(19) United States
(12) Patent Application Publication
(10) Pub. No.: US 2005/0154620 A1
(43) Pub. Date: Jul. 14, 2005

(54) Online Group Reservation System

(75) Inventors: Timothy Noel Hentschel, Irvine, CA (US); John Alan Prince, San Diego, CA (US)

Correspondence Address: LEXYL TRAVEL TECHNOLOGIES INC., P.O. BOX 927895, SAN DIAGO, CA, 92192, US

(73) Assignee: LEXYL TRAVEL TECHNOLOGIES, INC., San Diego, CA (US)

(21) Appl. No.: 10/707,733

(22) Filed: Jan. 8, 2004

(51) Int. Cl. G06F 17/60

(52) U.S. Cl. 705/5; 705/6

(57) ABSTRACT

The Lexyl Online Group Reservations System is a network computer system and method in which a groups travel coordinator may gather information from Internet hotel booking engines and hotels in their desired destinations worldwide. The invention accomplishes this by collecting all necessary information from the group travel coordinator. It then uses this information to conduct a search of the Internet for rooms fitting the group coordinators needs. Once its search is completed, the system will automatically notify the hotel group managers through electronic mail. The group managers are then invited through this electronic mail invitation to enter the system and view the group travel coordinators booking needs. Once they have the required information, the system allows the hotel managers to respond with all necessary information about their hotel for the group travel coordinator to make their decision.

### BACKGROUND OF INVENTION

Many online travel companies such as “expedia.com” and “hotels.com” have limitations based on the GDS (Global Distribution Systems) that they were built on. As a result, they cannot book over 4 rooms per night in the same hotel within the same booking. As these systems have grown in popularity, the hotels have used these travel companies wholesale systems to give these and other online travel companies preferential pricing over their competition. In exchange, the travel companies have given these hotels preferential placement in order to increase the sales of rooms at these preferred hotels. In order for these hotels to use these online wholesale systems they must load in independent hotel inventory. This inventory is called allotments. These allotments are what the group booking system searches and combines in order to complete the necessary number of rooms indicated in the group posting.

There are other online travel companies such as “priceline.com” that use auctions to book hotel rooms for their customers, but the auction involves the customer bidding on pre-negotiated rate contracts. These contracts have too many restrictions to book groups into. The Lexyl System allows for a reverse auction to take place after the online hotel booking engine inventory has been searched and automatic bids (“Autobids”) have been placed. The hotels and travel vendors are then invited to access the group posting and place bids in a reverse auction style. The reverse auction process may be conducted similarly to an auction, but it is not an auction in its strictest sense, it acts more as a venue to allow the hotels and travel vendors to sell rooms at any rate, as well as group travel coordinators to search for information without obligation. The system does not keep hotels from submitting rates that are higher than the lowest submitted rate. The system also does not obligate the group travel coordinator to complete the transaction. Some auctions use a single-bid process, each bidder is allowed to bid once per auction, unlike the auctioning process whereby each bidder is allowed to beat his previous bid. With a single-bid system the bids are usually hidden until all bids are collected. The Lexyl System allows for bidders to hide their bids or show their bids to other bidders depending on the hotels or travel vendors specifications while submitting their bid. The System as allows a hotel or travel vendor to submit multiple bids on the same group reservation request. In traditional manual systems, rates are gathered over the phone by calling several hotels, or by calling a third party. That third party is usually a travel agent, who then will call the hotels, or call another outside party called a wholesaler. The Lexyl System will alert all hotels as well as automatically search online wholesaler inventory. A process that before could take days is shortened down to a fraction of the original time required with the Lexyl Online Group Reservations System.

### SUMMARY OF INVENTION

The invention provides a software interface and method in which a group travel coordinator may communicate with hotel and travel vendors through the Internet. The system and method also allows group travel coordinators to access and accept bids placed from multiple online hotel booking engines in real-time. In this system and method, the bids received directly from hotels and travel vendors can be submitted multiple times and at any time after the group is posted. The system and method collects these bids from the hotels and keeps the bids hidden from all parties except the group travel coordinators. The group coordinator may then consider bid/hotel information and accept any of the hotel, travel vendor or online hotel booking engine bids at anytime. This system will allow groups to access and book hotel reservations completely online.

### BRIEF DESCRIPTION OF DRAWINGS

The following is a brief description of the figures presented herein provide a complete disclosure of the invention.

FIG. 1 “Diagram of System Operations.” This figure charts the flow of operations once the system is initiated by a group travel coordinator.

FIG. 2 “Group Travel Coordinator Request Form.” This figure displays the information a group travel coordinator must submit in order to gain access to the system.

FIG. 3 “Hotel Registration Form.” This figure displays the information a hotel must submit in order to gain access to the system.

FIG. 4 “Travel Vendor Registration Form.” This figure displays the information a travel vendor must submit in order to gain access to the system.

FIG. 5 “Hotel Group Information Page.” This figure contains automatic, hotel, and travel vendor bids within a hotel account.

FIG. 6 “Bid Submission Form.” This figure displays the information a hotel must give the computer in order to submit their hotel for the group travel coordinators evaluation.

FIG. 7 “Travel Coordinator Group Information Page.” This figure contains automatic, hotel, and travel vendor bids within a group travel coordinator account.

FIG. 8 “AutoBid Small Group Bid Acceptance Form.” This figure displays the information a group travel coordinator must give the system in order to confirm the hotel reservation for a group smaller than 4 rooms per night.

FIG. 9 “AutoBid Large Group Acceptance Form.” This figure displays the information a group travel coordinator must give the system in order to confirm the hotel reservation through a third party wholesaler for a group larger than 4 rooms per night.

FIG. 10 “Direct Bid Acceptance Form.” This figure displays the information a group travel coordinator must give the system in order to confirm their group hotel reservations directly with the hotel.

FIG. 11 “Active Group Postings Table.” This may only be viewed within an administrator account. It displays all pending group bookings in real-time.

FIG. 12 “Administrator Group Information Page.” This figure contains automatic, hotel, and travel vendor bids within an administrator account.

FIG. 13 “Accepted Group Postings Table.” This may only be viewed within an administrator account. It displays all confirmed group bookings in real-time.

FIG. 14 “Accounting Information Page.” This figure contains group travel coordinator billing information and commissions collection status.

### DETAILED DESCRIPTION

The present invention relates generally to electronic commerce and more predominantly to searching and confirming a block of hotel rooms for a group through the Internet.

Throughout the disclosure given herein and the following, the term “Posting” is used to describe the needs of a group travel coordinator, and the term “bid” is used to describe customized feedback and rates as well as stored hotel pictures and descriptions submitted by hotels or travel vendors. The term “AutoBid” is used to describe rates as well as stored hotel pictures and descriptions that is automatically searched and submitted by the system based on the Group Travel Coordinators posting requests.

### Detailed Description of the Online Group Reservations System

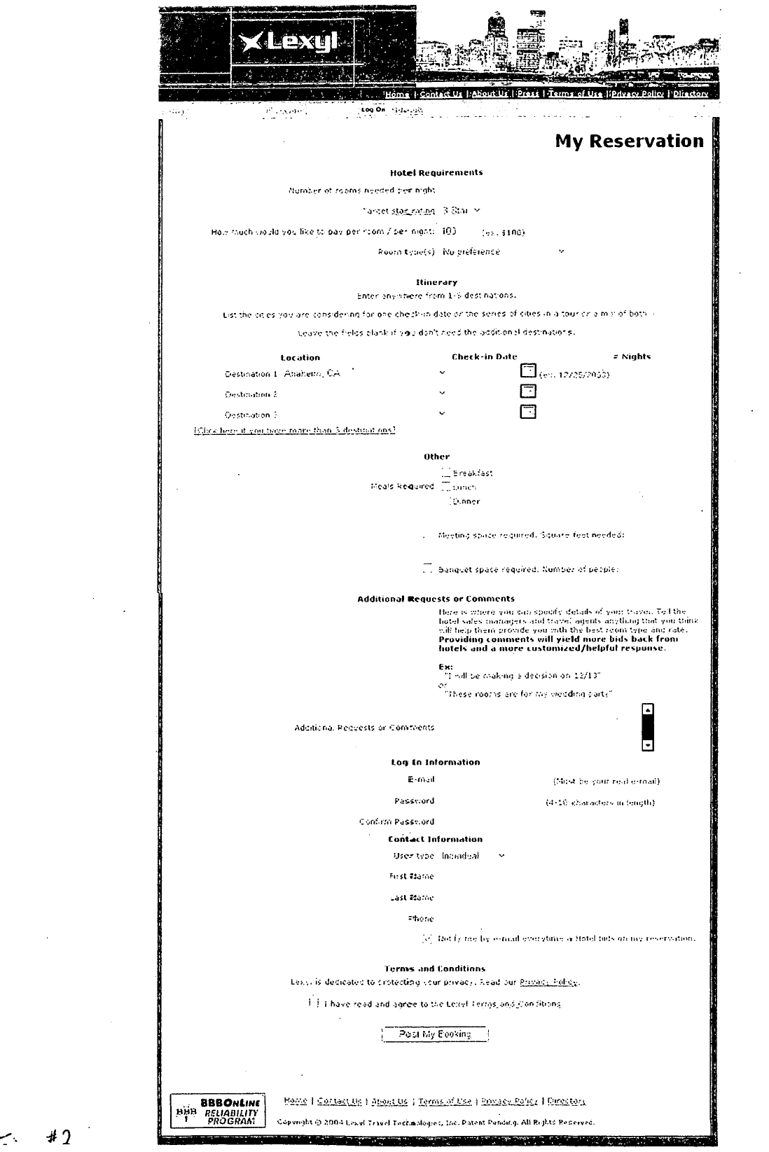

The picture in FIG. 2 is called the group travel coordinators submission form. It contains all necessary information request fields to complete a group reservation completely online.

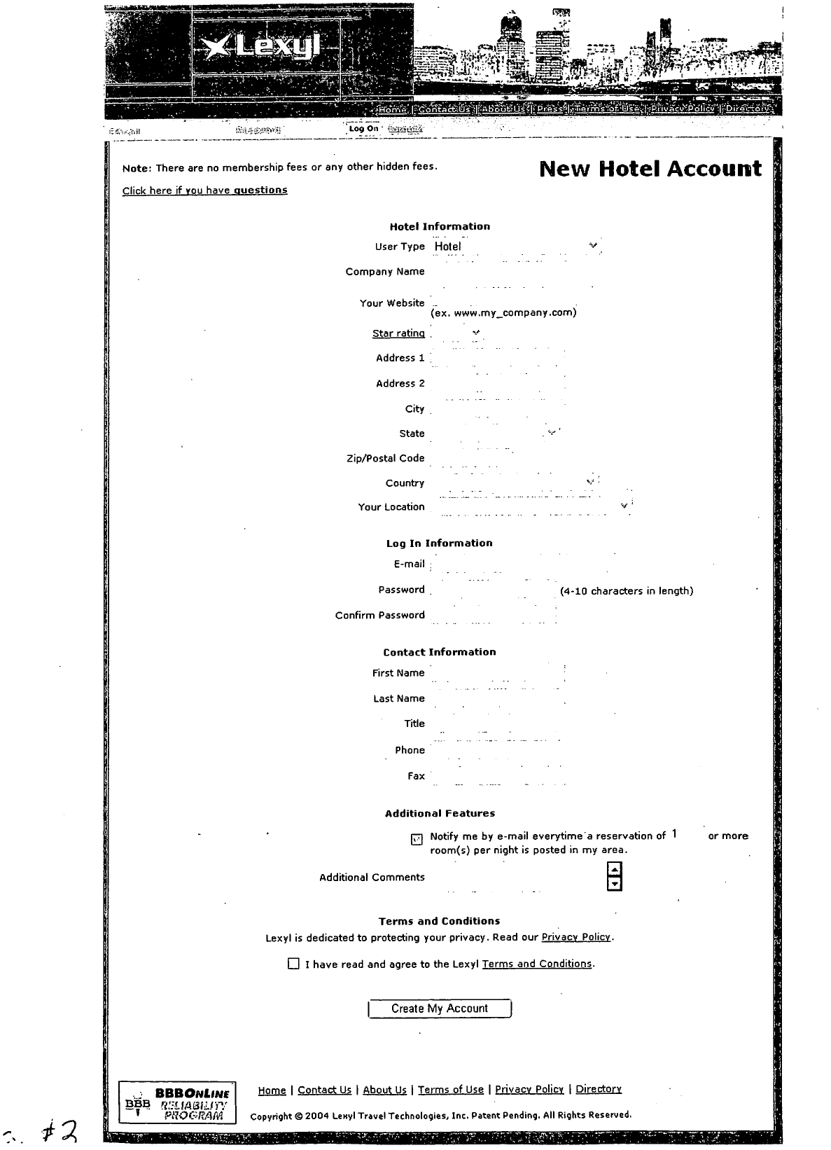

In FIG. 3, there is a picture of the hotel registration form. This form must be filled out in order for the hotel to become a member. This form contains all necessary information for a group coordinator to do a full evaluation of the hotel. Once the hotel has become a member, they may gain access into the group posting database.

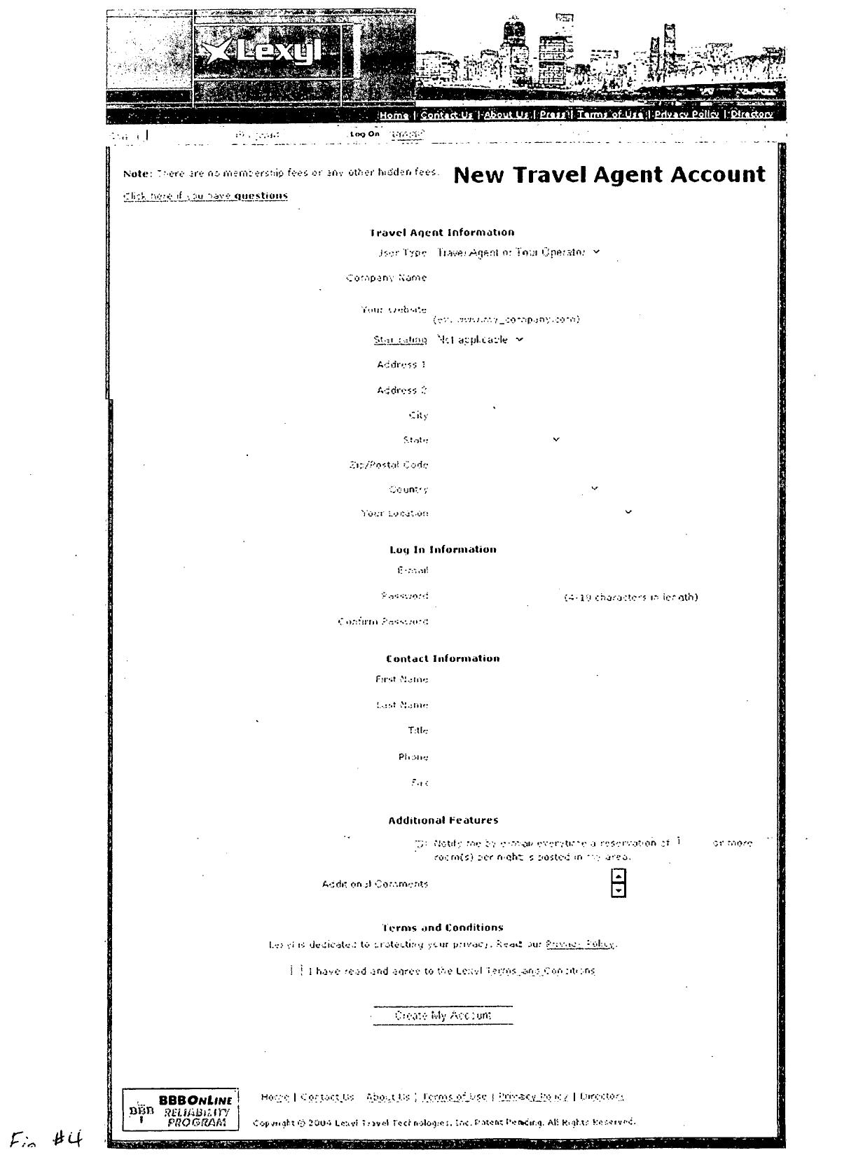

Turning to FIG. 4 is a picture of the travel agent registration form. This form utilizes the same database as the hotel registration form with only a few differences. When the information is transformed into the directories, it labels the account as a travel agent. The other difference is a travel agent account will be notified of all group postings in any destinations within any star rating according to the agents requested rooms per night account setting.

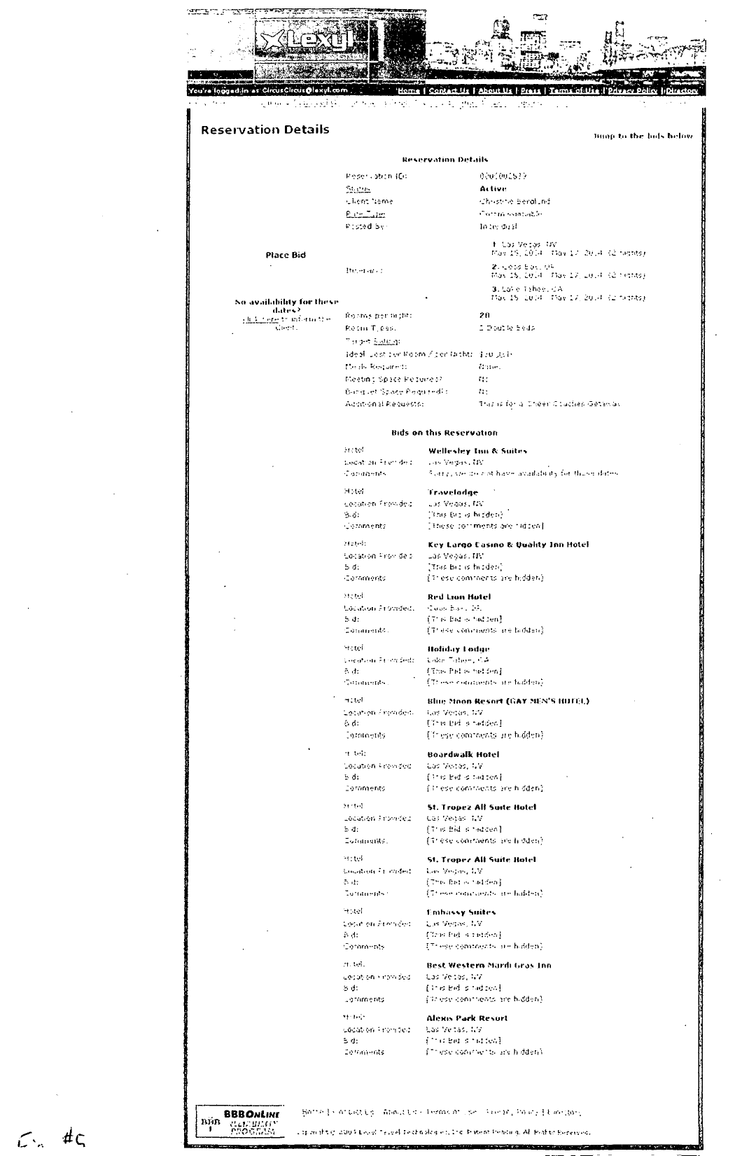

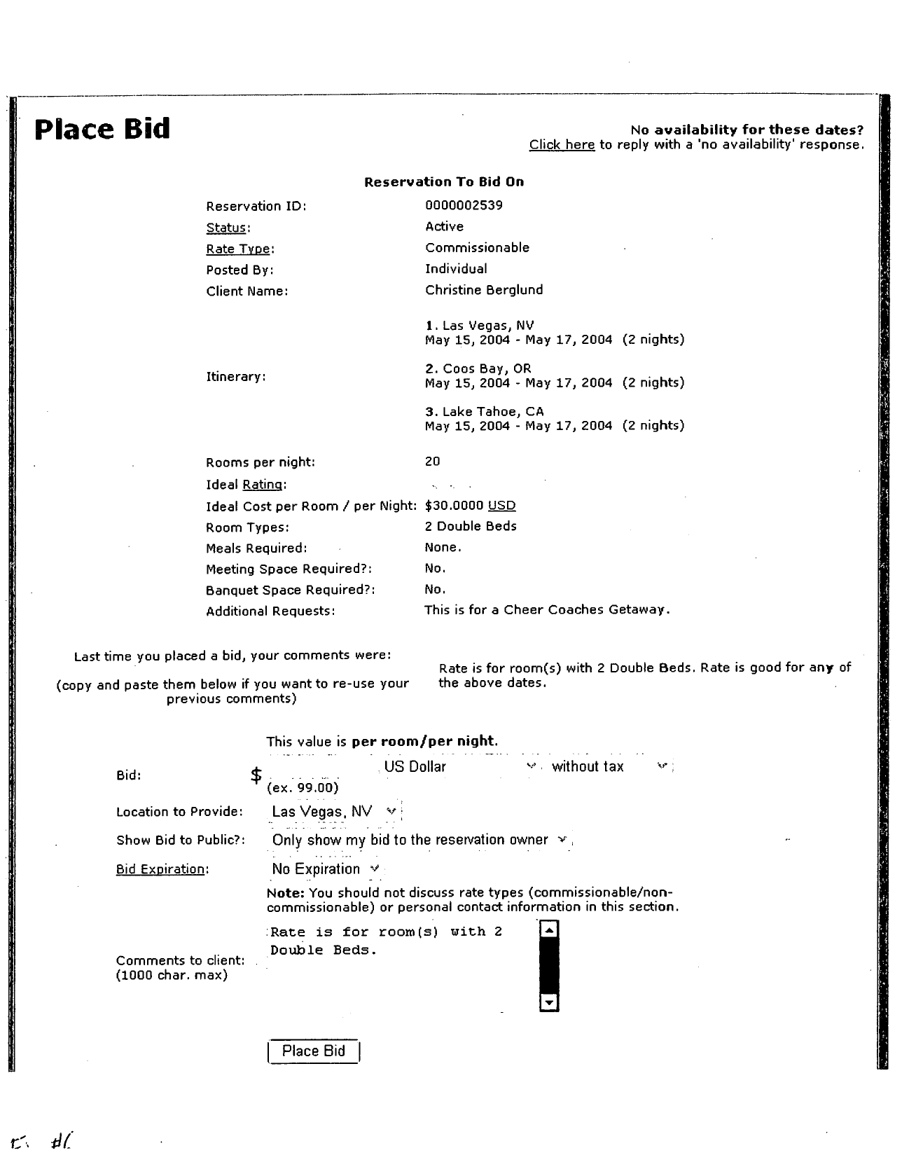

Once a hotel or travel vendor is a member they will start receiving Bid Notification Emails (“BNE”). These emails will direct them to the Web page pictured in FIG. 5 via an Internet universal resource location (“URL”). This page is called the Travel Coordinator Group Information Page. It contains all information for the type of accommodations, price, dates, and destination needs for the group. The hotel and travel vendors can also view which hotels and travel vendors have already submitted bids directly or have been submitted via the automated group bidding system. These bids will have all pertinent information such as rate or comments hidden from all other hotels if the hotel selected to hide this information on the bid submission form pictured in FIG. 6. This page will also show which hotel the group has selected, when the group selects a hotel or travel vendor. The group coordinator“s name is shown on groups 5 rooms per night or larger, but all other direct contact information is hidden until the hotel selects a hotel. This is done in order to protect the group coordinator from sales solicitations during the hotel and travel vendor evaluation period.

During the open bidding process, the hotels and travel agents can respond by entering in their information into the bid submission form, as shown in FIG. 6. This information is then deposited into the bid database. Once the rate, expiration date, and comments are converted into a computer readable format, the information is then matched with the hotel information database. The hotel information database contains information such as pictures and descriptions on over 45,000 hotels worldwide. If no information is found on the hotel in the hotel information database, the system then matches the bid information with information from the hotels Web site, which is deposit in the hotel“s membership database. Once the information has been matched, the group travel coordinator is then invited through an email containing a URL to view the information via the Internet in their password protected account.

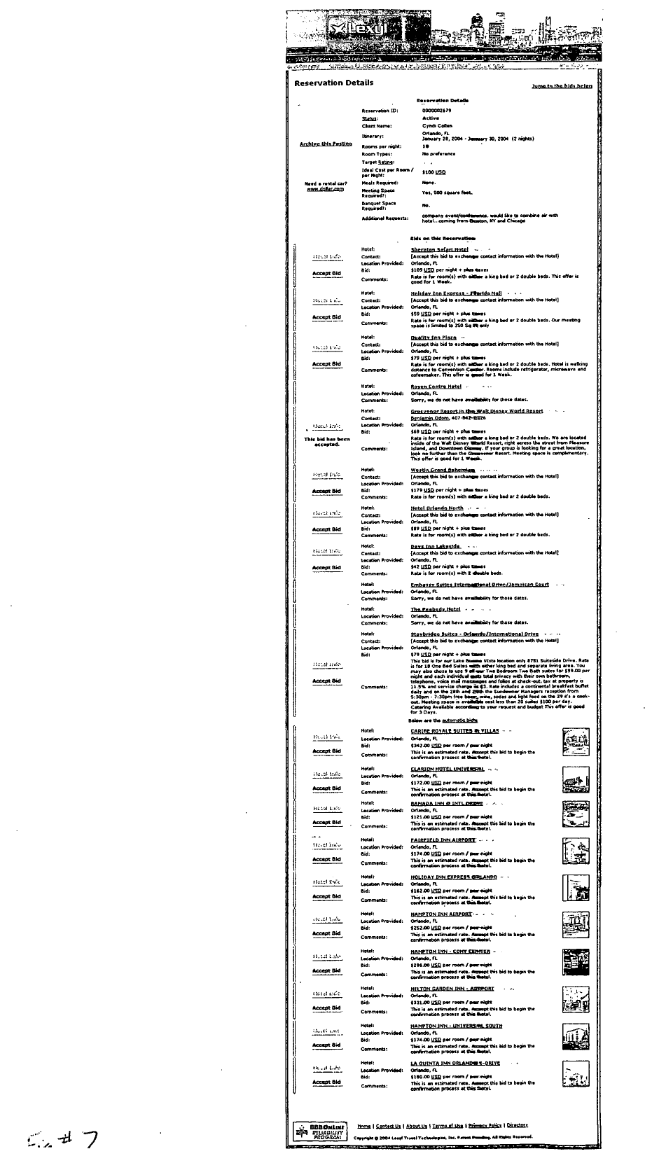

The information that the group travel coordinator will view is pictured in FIG. 7. This format separates direct hotel and travel agent bids on top, while leaving the automatic bids collected at group travel coordinators initial posting request separated by a border that labels them automatic bids at the bottom. All information collected from the hotel is available to the group travel coordinator in order for them to evaluate all offers equally. Direct contact information from the hotel representative is hidden until the group travel coordinator accepts the hotel offer. In order to accept the hotel offer the group travel must first qualify themselves via the Internet with a credit card, or via the phone with a Lexyl representative.

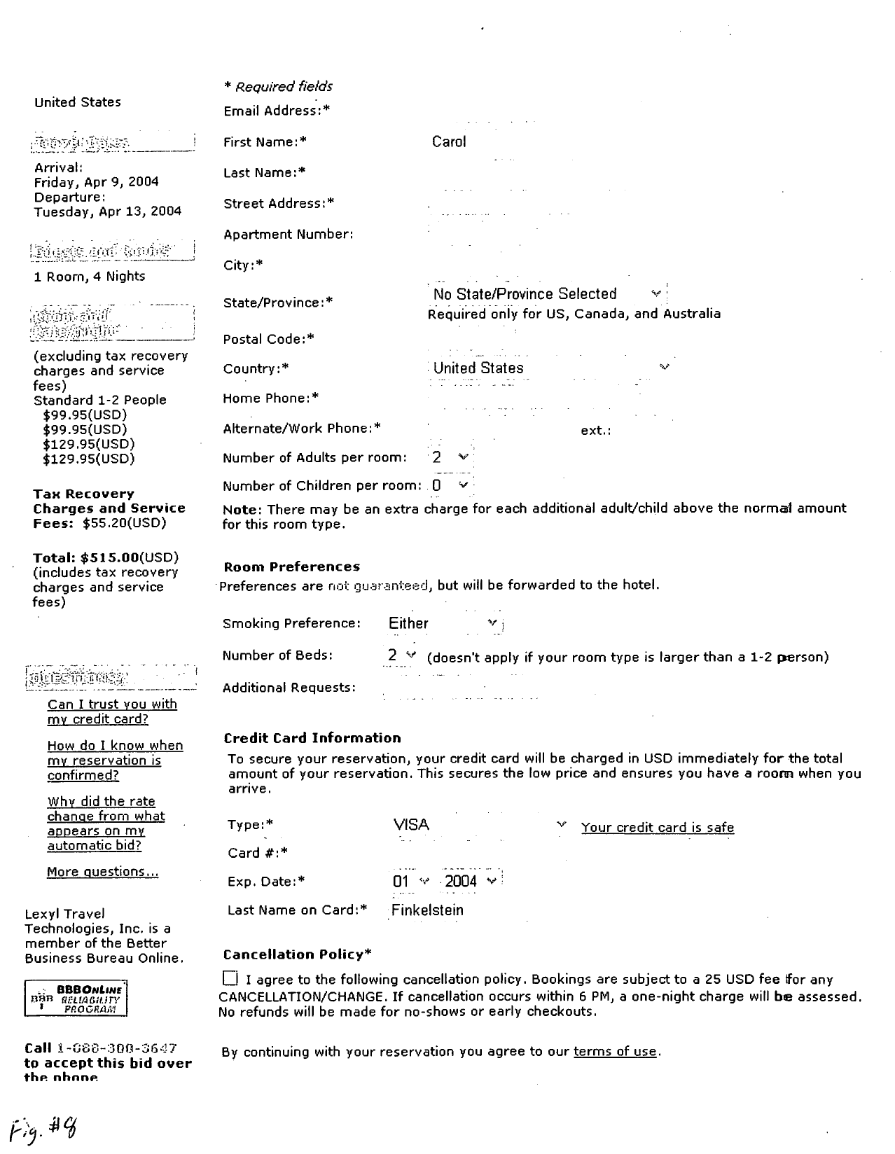

Once the group travel coordinator has done its due diligence with the information in FIG. 7, they will be ready to move onto the page pictured in FIG. 8. This page is reached by clicking on the “Accept Bid” button on FIG. 7. The picture in FIG. 8 shows the accept bid page for automatic bids for smaller group reservations consisting of 4 rooms per night or less. These bids are attached with special conditions that the group coordinator must agree to before accepting the automatic bid.

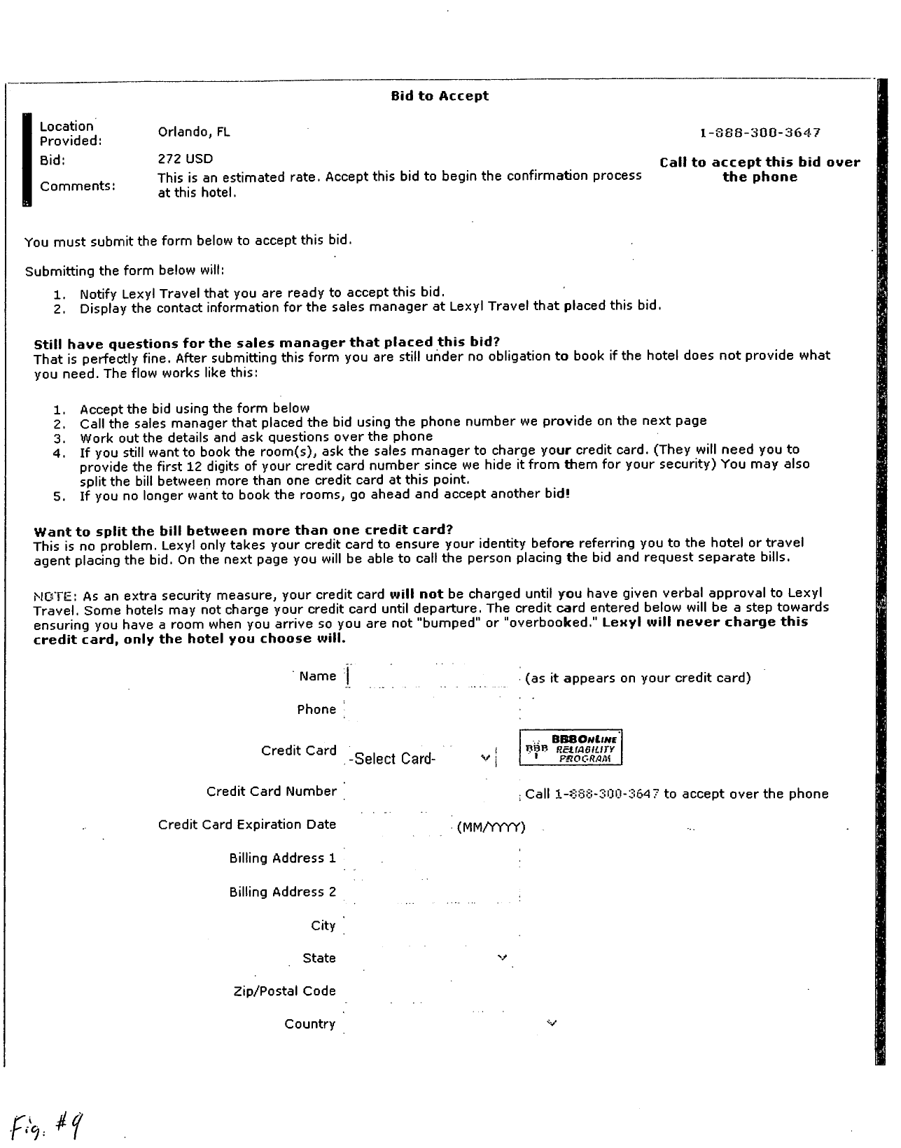

The automatic bid acceptance form for large groups is shown in FIG. 9. A large group is defined in our system as 30 rooms per night or less. This definition is a result of the constraints of combining multiple online wholesaler allotments. Once a group coordinator has accepted the automatic group bid with their credit card, a rooming list will be taken and their rooms will be confirmed through multiple online hotel booking engines.

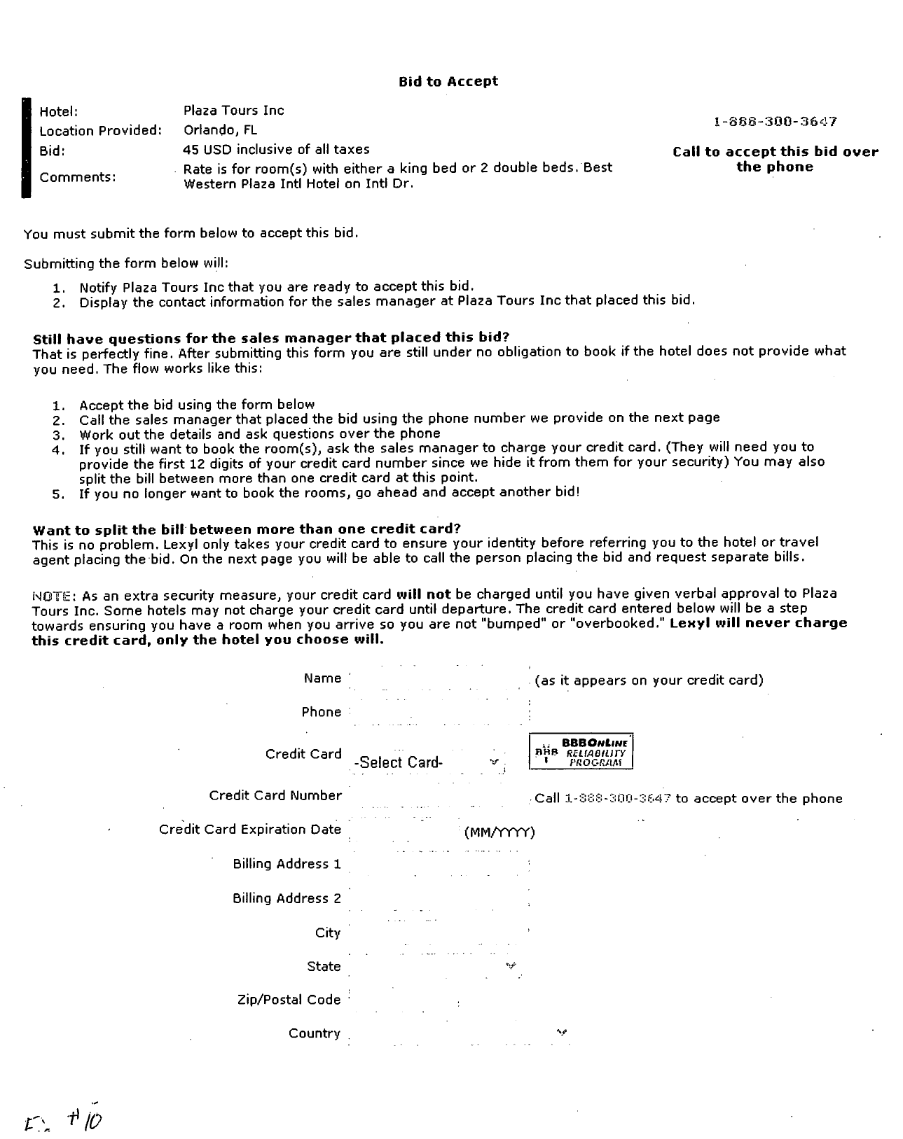

The last version of the bid acceptance form is pictured in FIG. 10. This web page is very similar to FIG. 10 in appearance, but when the group travel coordinator either confirms online with their credit card or via the phone, the system will automatically swap contact information between the buying and selling parties in order for the transaction to be completed directly through the hotel or travel vendor that submitted the accepted bid.

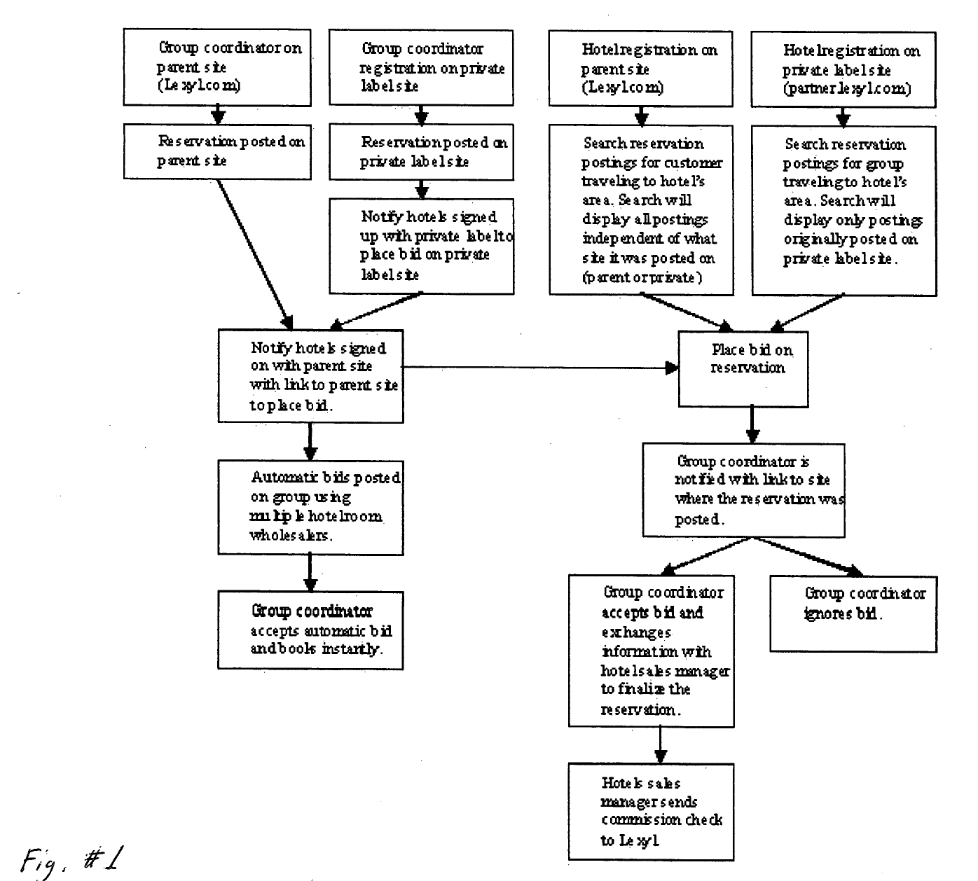

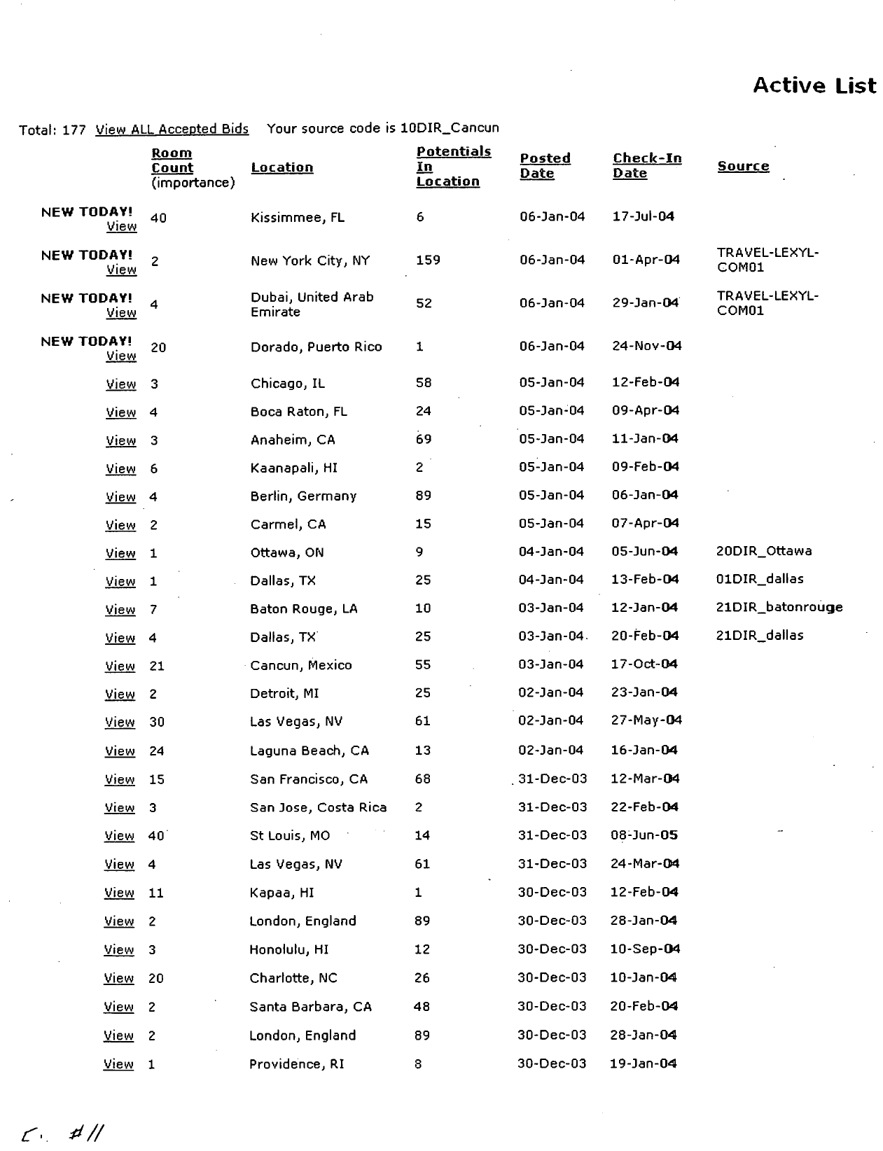

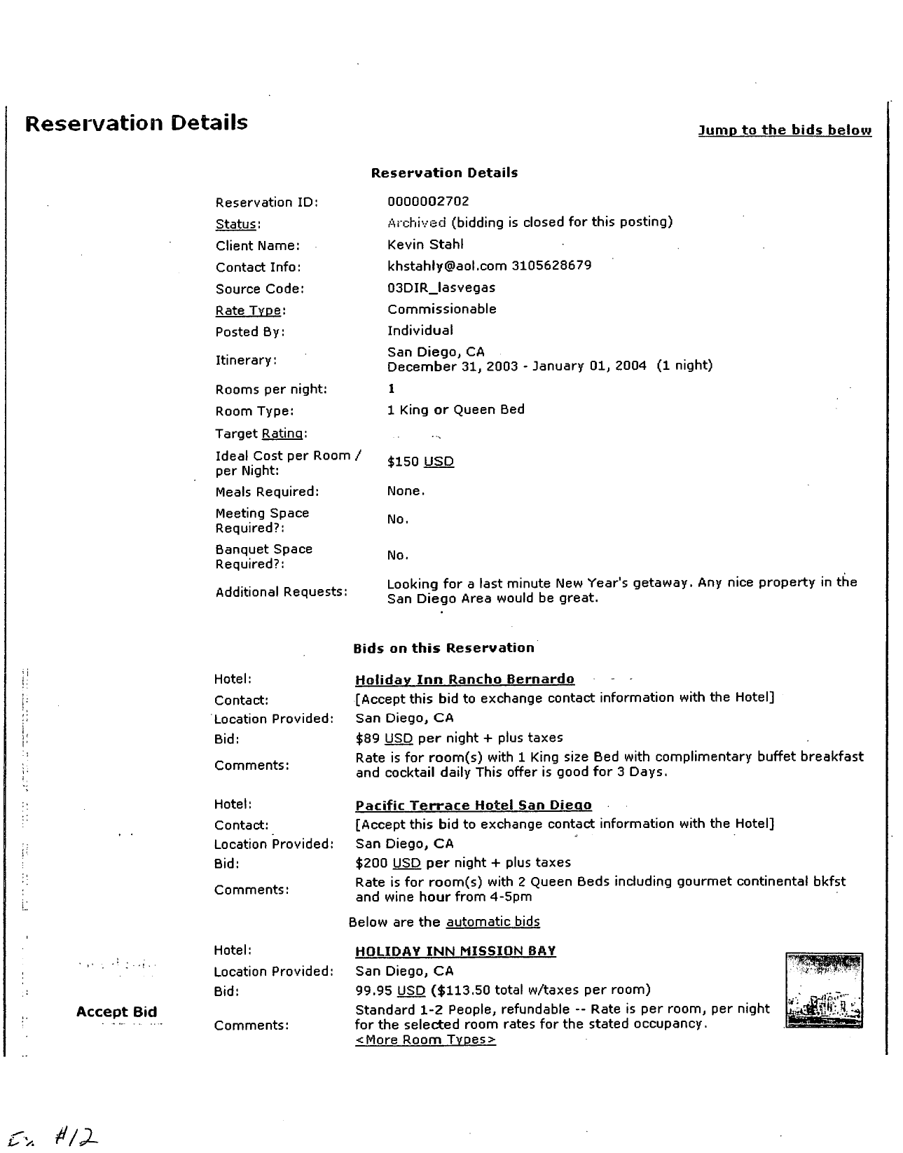

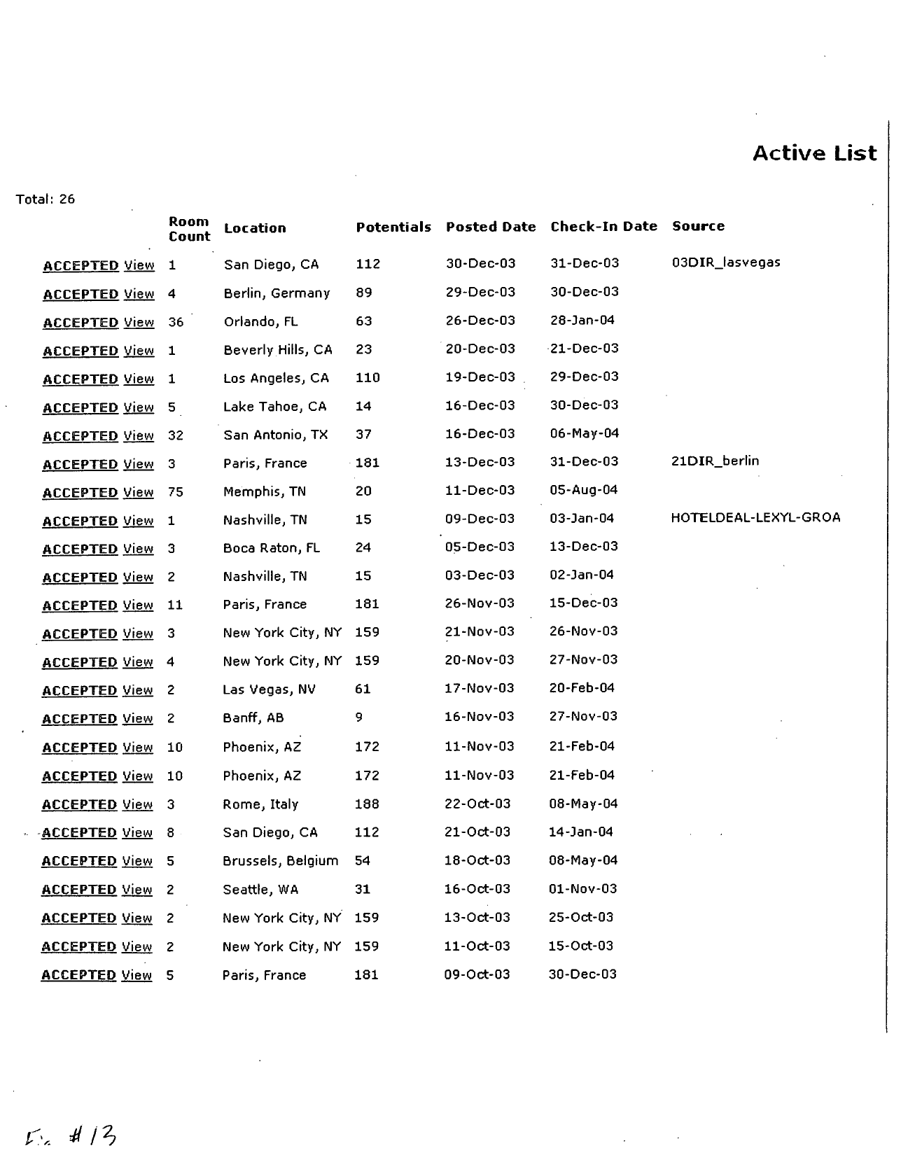

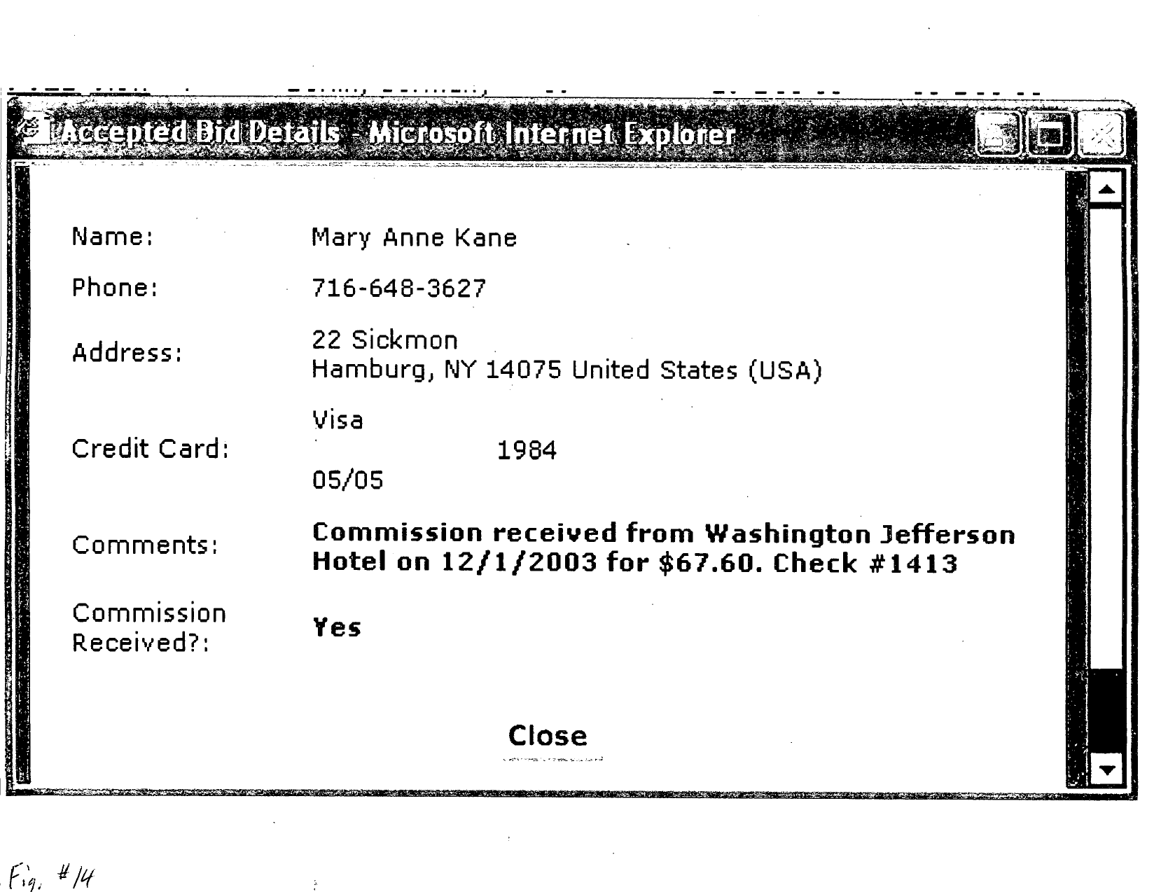

The administrator interface is pictured in FIG. 11, FIG. 12, FIG. 13 and FIG. 14. These figures confirm the success of the model pictured in FIG. 1. The first table in FIG. 11 shows all group travel coordinator postings that our actively looking for rooms for their group within the system as of Jan. 6, 2004. From this table in the administrative interface a person may view all information for all parties using the system at anytime within the group booking process. They may access this information by clicking on the underlined link labeled view. This link will access the administrator version of the Group Information Page as pictured in FIG. 12. This page allows the administrator to monitor the progress of all active groups in order to make sure their needs are met, as well as contact the group travel coordinator directly when a bid meets all of these needs.

The purpose for this contact is to help confirm the group onto a hotel. Once this group has been confirmed the system automatically moves the group from the table in FIG. 11 to the table in FIG. 13. This page is called the “Accepted Group Postings Table” and contains all information about all parties that have used the system and completed a group booking. Within this table an administrator may access the accepted groups billing information by clicking on the link called “Accepted.” This link will bring up the page pictured in FIG. 14. This figured is called the “Accounting Information Page” because it also contains the status of paid commissions on accepted groups. This allows an administrator to track all commissions that are received or become past due.

1-16. (canceled)

17. A system for facilitating hotel room transactions, said system comprising:
a server, said server providing for:
a posting;
a reverse auction heuristic;
a plurality of bids, said plurality of bids including a successful bid;
wherein said server is configured to receive said posting;
wherein said server is configured to receive said bids in response to said posting; and
wherein said server is configured to selectively identify said successful bid from said plurality of bids using said reverse auction heuristic

18. The system of claim 17, further comprising an automated bid, wherein at least one said bid in said plurality of bids is said automated bid.

19. The system of claim 18, wherein said automated bid is said successful bid.

20. The system of claim 17, said posting providing for a plurality of posting attributes, said posting attributes including at least three of: (a) a number of rooms; (b) a target star rating; (c) a preferred price; (d) a room type; (e) a location; (f) a check-in date; (g) a number of nights; (h) a meeting space requirement; and (i) a banquet space requirement.

21. The system of claim 17, wherein said posting relates to a plurality of rooms.

22. The system of claim 17, wherein said successful bid relates to a plurality of rooms.

23. The system of claim 22, wherein said plurality of rooms relate to a plurality of hotels.

24. The system of claim 17, said server further comprising a bidding interface and a bidding entity, wherein said bidding interface provides for said bidding entity submitting more than one said bid in response to said posting.

25. The system of claim 17, wherein said posting is received from a posting entity, and wherein said posting entity is not required to accept said successful bid.

26. The system of claim 17, wherein said posting is received from a posting entity, and wherein said posting entity is a group travel coordinator.

27. The system of claim 17, further comprising a plurality of bidding entities, wherein said server is configured to receive said plurality of bids from said plurality of bidding entities, said plurality of bids including a first bid and a second bid, wherein said plurality of bidding entities a first bidding entity and a second bidding entity, wherein said first bid is submitted by said first bidding entity, wherein said second bid is submitted by said second bidding entity.

28. The system of claim 27, wherein said first bid is hidden from said second bidding entity.

29. The system of claim 27, wherein said first bid is accessible by said second bidding entity.

30. The system of claim 17, wherein said reverse auction heuristic is performed in a substantially real-time manner.

31. The system of claim 17, further comprising a plurality of completed membership forms from a plurality of bidding entities, wherein each said bidding entity submitting said bids is associated with at least one said completed membership form.

32. The system of claim 17, further comprising a plurality of completed bid submission forms, wherein each said bid is associated with at least one said completed bid submission form.

33. The system of claim 17, wherein at least one said bid is associated with a special condition.

34. The system of claim 17, wherein said server is configured to receive an acceptance relating to said successful bid.

35. A system for obtaining a hotel reservation, comprising:
a buyer interface, said buyer interface providing for:
a posting;
a reservation;
wherein said buyer interface provides for submitting said posting;
wherein said buyer interface provides for receiving said reservation in response to said posting in a substantially real-time manner; and
wherein said posting includes a location, a price, a number of rooms, and a check-in date.

36. A method for facilitating a hotel reservation, comprising:
populating a database with a plurality of participating bidders;
configuring a plurality of reverse auction parameters;
providing an online form to accept postings from a plurality of potential buyers;
performing a reverse auction in accordance with at least one said reverse auction parameter to identify a successful bid from a plurality of bids received form said plurality of participating bidders; and
transmitting an offer to at least one said potential buyer, wherein said offer is generated using said successful bid;
wherein said reverse auction allows at least one said participating bidder to submit more than one said bid in response to said posting.

37. The method of claim 36, wherein at least one bid in said plurality of bids is an automated bid.

38. The method of claim 36, wherein said plurality of bids includes a first bid and a second bid, wherein said plurality of participating bidders includes a first bidder and a second bidder, and wherein said first bid is hidden from said second participating bidder.
